(19) United States
(12) Patent Application Publication
(10) Pub. No.: US 2013/0167697 A1
(43) Pub. Date: Jul. 4, 2013

(54) ULTRA HIGH PRESSURE PUMP

(71) Applicant: Darren Reukers, Campbellfield (AU)

(72) Inventor: Darren Reukers, Campbellfield (AU)

(73) Assignee: TECHNI WATERJET PTY LTD, CAMPBELLFIELD (AU)

(21) Appl. No.: 13/822,409

(22) PCT Filed: Sep. 12, 2011
(86) PCT No.: PCT/AU11/01171

§ 371 Date: Mar. 12, 2013

(30) Foreign Application Priority Data
Sep. 13, 2010 (AU) 2010904106

(51) Int. Cl. F04B 49/06; B26F 3/00

(52) U.S. Cl. CPC F04B 49/065; B26F 3/004
USPC 83/53; 417/44.2; 83/74

(57) ABSTRACT

An ultra high pressure pump comprising a servo motor coupled to a piston having a head arranged within a cylinder to define a pumping chamber, whereby the servo motor rotation causes reciprocal displacement of the piston to pressurise fluid in the pumping chamber to pressures greater than 50,000 psi, the servo motor having a feedback loop coupled to a computer, the feedback loop including a pressure feedback signal to control the pump pressure in real time.

This invention relates to an ultra high pressure pump particularly for use in waterjet cutting apparatus.

### BACKGROUND OF THE INVENTION

Waterjet cutting apparatus has been used for some years to cut a variety of materials such as steel, aluminium, glass, marble, plastics, rubber, cork and wood. The work piece is placed over a shallow tank of water and a cutting head expelling a cutting jet is accurately displaced across the work piece to complete the desired cut. The cutting action is carried out by the combination of a very high pressure jet (up to 90,000 psi) of water entrained with fine particles of abrasive material, usually sand, that causes the cutting action. The water and sand that exit the cutting head are collected beneath the work piece in the tank.

It is in the industry associated with waterjet cutting that the expression “ultra high pressure” (UHP) waterjets are used to define a process where water is pressurised above 50,000 psi and then used as a cutting tool. The high pressure water is forced through a very small hole which is typically between 0.1 mm and 0.5 mm in diameter in a jewel which is often ruby, sapphire or diamond.

Although pressures greater than 50,000 psi are defined as ultra high pressure it is envisaged that these pressures could be as great as 100,000 psi.

In our co-pending patent application WO 2009/117765 we disclose an ultra high pressure pump that has been specifically designed for use with a particular type of waterjet cutting apparatus. The issues of compactness and efficiency are critical to pumps of this nature and there is a need for pump to operate reliably at ultra high pressures. There is also a need for the pumps to be designed in a manner that they can be readily fitted to many types of existing waterjet cutting machines. There is also a need for the pumps to regulate the pressure accurately with minimal pressure variation.

It is these issues that have brought about the present invention.

### SUMMARY OF THE INVENTION

According to a first aspect of the present invention there is provided an ultra high pressure pump comprising a servo motor coupled to a piston having a head arranged within a cylinder to define a pumping chamber, whereby the servo motor rotation causes reciprocal displacement of the piston to pressurise fluid in the pumping chamber to pressures greater than 50,000 psi, the servo motor having a feedback loop coupled to a computer, the feedback loop including a pressure feedback signal to control the pump pressure in real time.

According to a further aspect of the present invention there is provided an ultra high pressure pump comprising a servo motor adapted to axially rotate a hollow rotor shaft in alternating directions, the servo motor having a stator positioned co-axially around the hollow rotor shaft with the interior of the rotor shaft being co-axially coupled to drive means to convert axial rotation into reciprocal displacement, the drive means having opposed ends, each end coupled to a piston having a head arranged within a cylinder to define a pumping chamber between the head of the piston and the cylinder, whereby alternating rotation of the rotor shaft causes reciprocal linear displacement of the pistons to pressurise fluid in the pumping chambers to pressures greater than 50,000 psi, the servo motor including an encoder to monitor position or velocity of the drive means, means to monitor the current flowing through the stator and a pressure sensor coupled to the output of the pumping chambers, whereby signals from the encoder, pressure sensor and stator are fed back to a computerised control unit to ensure that the pump operates at a selected pressure.

Preferably the output of the pumping chambers is coupled to a pressure transducer.

### DESCRIPTION OF THE DRAWINGS

An embodiment of the present invention will now be described by way of example only with reference to the accompanying drawings in which:

FIG. 1 is a cross-sectional view of an ultra high pressure pump in accordance with an embodiment of the invention,

FIG. 2 is a cross-sectional view taken along the lines B-B of FIG. 1,

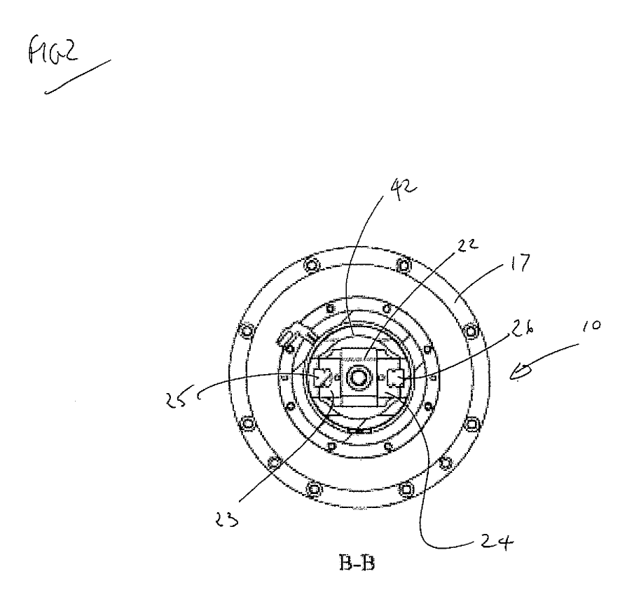

FIG. 3 is a perspective view of a ball screw supported by rails and linear bearings,

FIG. 4 is a perspective view of the ball screw,

FIG. 5 is a perspective view of a support for the ball screw, and

FIG. 6 is a flow chart showing the pump coupled to a waterjet cutting machine and illustrating the operational control.

### DESCRIPTION OF THE PREFERRED EMBODIMENT

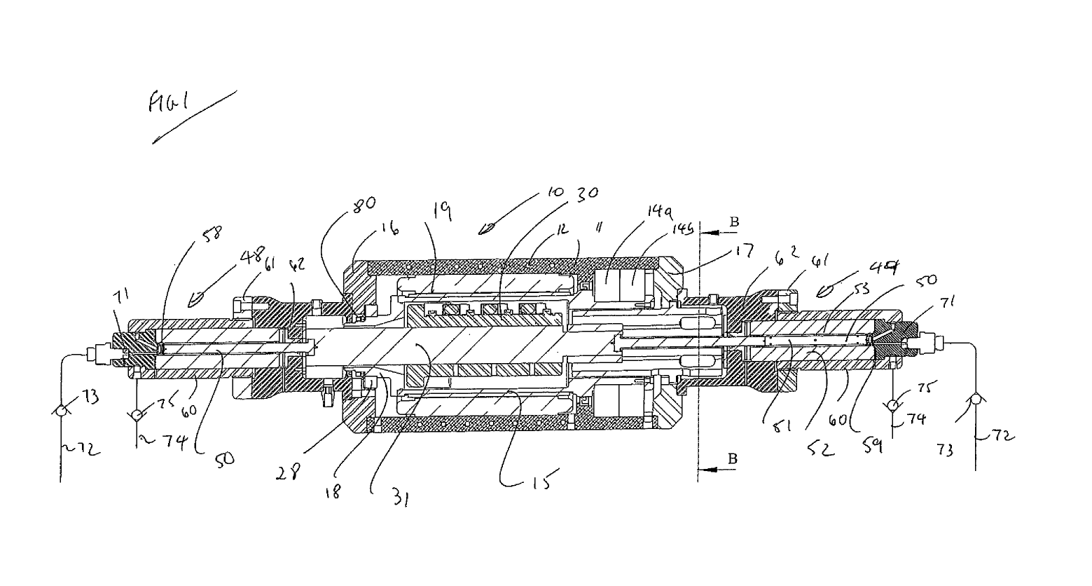

As shown in FIG. 1, an ultra high pressure pump 10 comprises a cylindrical housing 11 that has embedded therein water cooling jacket 12. The housing 11 has end caps 16, 17 that support a hollow rotor shaft 15 about windings 19 of a servo motor. One end 13 of the rotor shaft 15 is supported by annular bearings 14A, 14B located between the housing 11 and the rotor shaft 15. The other end 18 of the rotor shaft 15 is supported with the end cap 16 by a bearing 28. The end 18 also supports an encoder 80 housed by the end cap 16. The encoder 80 monitors position or velocity of the rotor shaft 15.

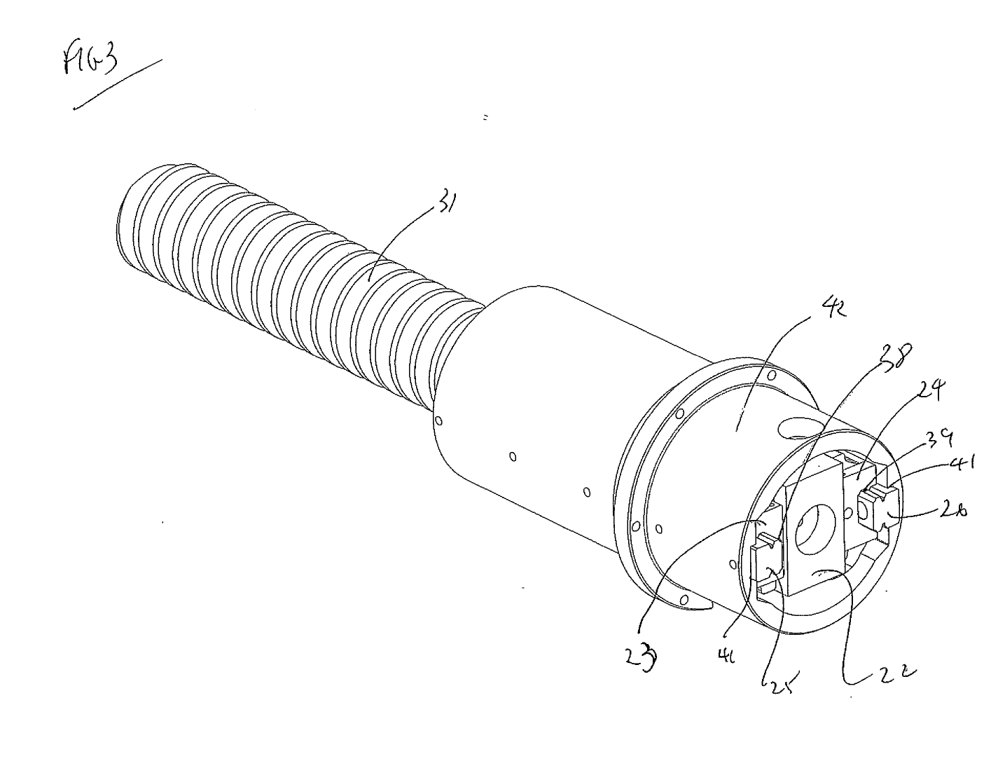

The rotor shaft 15 houses a ball screw nut 30 which is in turn threadedly engaged onto an elongated ball screw 31. The ball screw nut 30 is in direct engagement with the interior of the rotor shaft 15 and is constrained against linear movement to rotate with the rotor shaft 15. The screw 31 has a threaded exterior 20 with one end 22 machined square. The squared end 22 fits between opposed linear bearings 23, 24 which run on elongate opposed rails 25, 26 (FIG. 3). The rails 25, 26 extend past the end cap 17 of the housing 11.

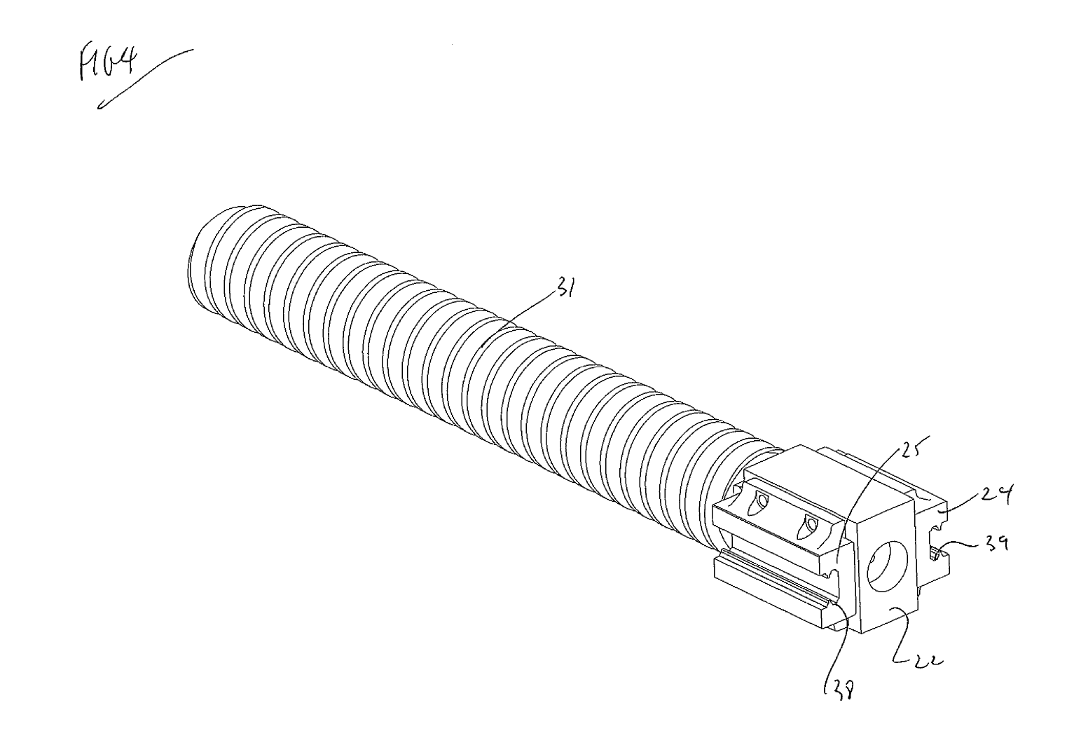

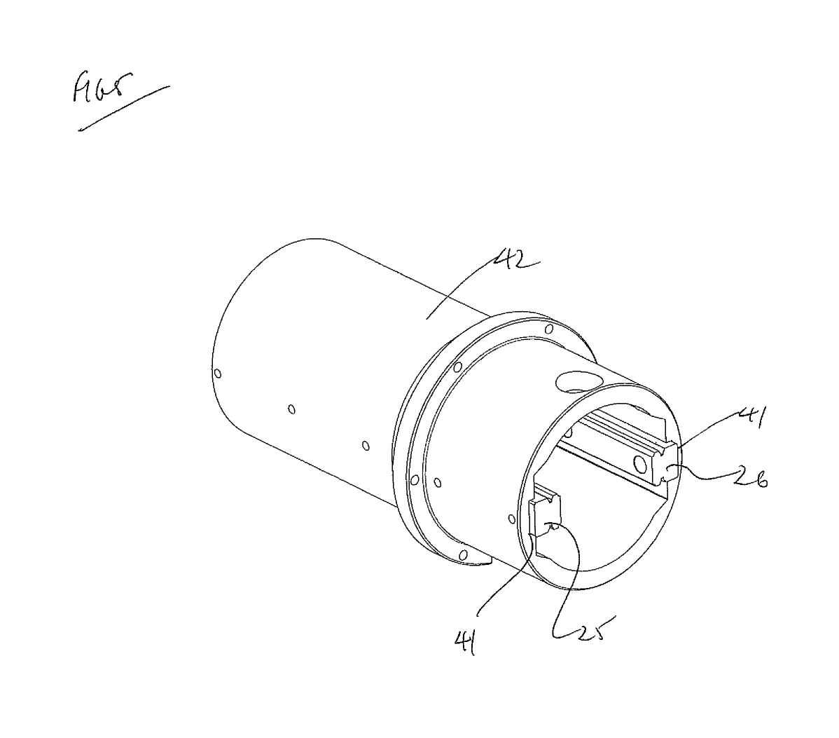

As shown in FIGS. 3 to 5 the squared end 22 of the ball screw 31 is supported by linear bearings 23, 24 that engage opposed surfaces. Each linear bearing 23, 24 has an outer surface that is grooved 38, 39 to accommodate an elongate rail 25, 26 which is in turn secured within a groove 41 in a cylindrical rail support 42 located within the rotor shaft 15. Suitable oil ways (not shown) are provided to provide passage of oil to the linear bearings 23, 24 and rails 25, 26 and the arrangement is such that the linear bearings 23, 24 by engaging the squared end 22 of the ball screw 31 prevent rotation of the ball screw 31 yet facilitate longitudinal displacement of the ball screw. The linear rails 25, 26 are fixed to the interior of the rail support 42 and the dovetailed cross section of each rail 25 or 26 provides a smooth running but highly toleranced fit between the bearing 23 or 24 and the rail 25 or 26.

As shown in FIG. 1 opposite ends of the ball screw are coupled to piston/cylinder pumping assemblies 48, 49. Each assembly 48, 49 comprises a cylinder body 52 with a narrow internal bore 53 in which a piston 50, 51 that is coupled to the end of the ball screw is arranged to reciprocate. The piston 50, 51 terminates in a head that would carry appropriate sealing rings (not shown) to define with the cylinder a pressure chamber 58, 59. Each cylinder 52 is in turn supported by a retaining sleeve 60 that is held onto the end of the pump via a flange 61 that is bolted to an adaptor 62 that is in turn bolted to the end cap 16 or 17 of the housing. The end of each cylinder retaining sleeve 60 supports a valve assembly that incorporates an end block 71 into which a water inlet 72 flows via an internal low pressure check valve 73 to an outlet pipe 74 of narrow diameter that is in turn controlled by high pressure check valve 75.

The servo motor causes the rotor shaft 15 to rotate which in turn rotates the roller nut 30 which is constrained from axial movement thus meaning that the ball screw 31 moves linearly within the roller nut 30. By reversing the direction of rotation of the rotor shaft 15, the screw 31 can thus be caused to reciprocate back and forth to give reciprocating motion to the pistons 50, 51 to in turn pressurise the water that is introduced into the compression chambers 58, 59 via the water inlets 72 to effect high pressure delivery of water from the outlets 74 at pressures greater than 50,000 psi and up to 100,000 psi.

Each valve assembly has the low pressure water inlet 72 controlled by the check valve 73 communicating with the compression chambers 58, 59 at a 45° angle to axis of the cylinder. The high pressure outlet 74 is positioned co-axial to the end of the cylinder having an internal high pressure check valve 75 and transfers the water at high pressure to an attenuator (not shown).

High pressure seals are positioned between the inner ends of the cylinders 52 and the pistons 50, 51 to prevent back pressure.

The servo motor which is used in the preferred embodiment is a brushless DC motor operating on a DC voltage of about 600 volts. This is a motor which is commonly used in machine tools and has traditionally been very controllable to provide the precision which is required in such machine tool applications. The pistons have a stroke of between 100 and 200 mm (preferably 168 mm) and reciprocate at approximately 60 to 120 strokes per minute. The movement of a piston in one direction lasts about 0.8 seconds. The pump is designed to operate in the most efficient mode with the delivery of water of between 2 L per minute and 8 L per minute.

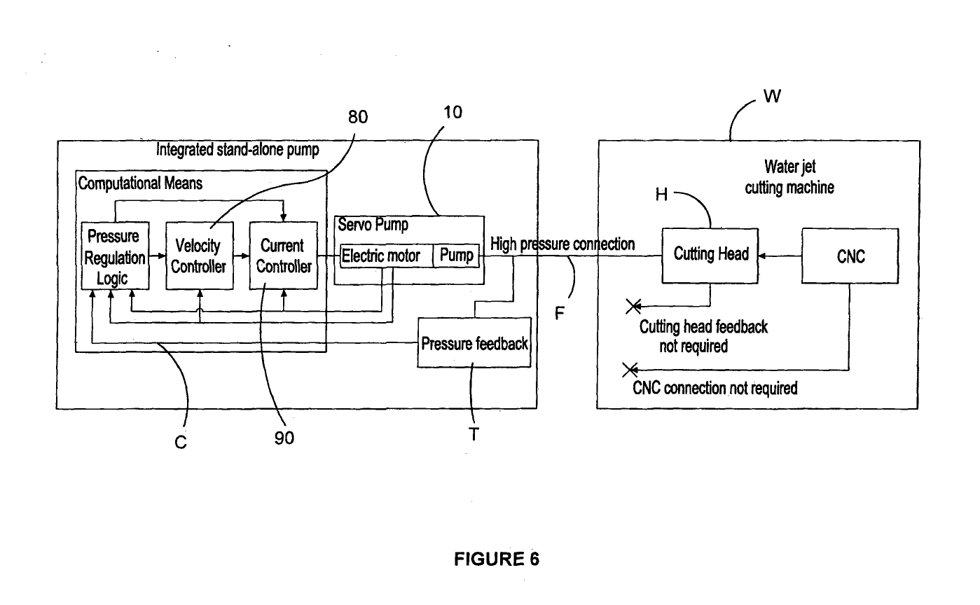

FIG. 6 is a flow chart showing the pump 10 coupled to a high pressure water cutting machine W that has a cutting head H and is controlled by a CNC controller. The CNC controller only controls the operation of the cutting machine W and not the high pressure pump 10.

As shown in FIGS. 1 and 6 the ultra high pressure pump 10 is coupled at either end to a source of water at the inlets 72. The high pressure water outlets 74 are coupled via an attenuator (not shown) to a high pressure water feed (F) which is coupled to the cutting heard H of the waterjet cutting machine W. A pressure transducer T provides a signal proportional to the outlet pressure which is fed back to a computer C associated with the pump 10. The pump 10 also includes feedback signals from the position or velocity encoder 80 and a stator current monitor 90. The computer C allows an operator to select a pressure usually between 50,000 psi and 100,000 psi with the pump then operating in real time to maintain that pressure.

As shown in FIG. 6 the pressure transducer T is positioned into the high pressure waterline between the high pressure check valves 75 and the cutting head H. This information is then fed directly into the computer C of the drive to enable accurate control of the pressure, in real time, without the need to know when and how much water is being dispersed from the cutting head.

Known systems require the feedback of the position, velocity, and current to be fed into the CNC controller where pressure adjustments are made by modifying the velocity to suit the given pressure and flow. This form of closed loop typically takes around 0.1 s from the time the information is received, processed and sent back to the drive. This is far too slow to allow the system to try and respond to a cutting head opening or closing without warning, and the need to know the required flow in order to apply the correct velocity. The closed loop at the computer C runs a real time control algorithm which receives and processes the information in every 0.0025 s which means that it can be completely un-tethered from the machine without any pre-knowledge of the cutting head opening or closing, or what size orifice is in the cutting head (which determines flow at a given pressure).

This feature when combined with the rapid acceleration/deceleration due to the highly compact design means that the pump can be connected to any machine and supply high pressure water that has a constant pressure with minimal pressure variation. Pressure variations are typically due to the plunger reversing time and compression of water within the cylinder (pressure pulse), and lag time in accelerating after the cutting head is opened or decelerating when the cutting head closes (dead head spike). The pump described herein has an extremely high power density which allows for the rapid response required from the mechanics to achieve the constant pressure required for waterjet cutting.

The pressure within the cylinder varies based on the compression and de-compression of the water within the cylinder. Water is approximately 15% compressible at 60,000 psi at 20 deg C., and cylinders expand and seals compress at these extreme pressures. This means the plunger must travel approx. 20% of its stroke to build up 60,000 psi pressure in order to open the high pressure check valves 75. In a position and velocity controlled system, this compression stage would take longer than with a pressure feedback system described above. This is because with the pressure feedback system, as the plunger slows down and begins to reverse the system sees the pressure begin to fall (because there is no additional water going into the system while water is continuing to escape through the orifice in the cutting head) and starts to accelerate faster and faster as the pressure drops. This acceleration continues throughout the compression stage until the check valves open and the additional water has re-pressurised the system to the target pressure where it then decelerates to the velocity required to maintain the desired pressure. The result is a significant reduction in the dip in pressure experienced during the reversing of the plungers (known as “pressure pulse”). A reduced pressure pulse (or constant pressure) is highly desirable in waterjet cutting applications as it allows for faster cutting speeds with higher quality edge finish due to reduced striations. Reduced pressure pulse also results in higher life of the high pressure components such as hoses, fittings, and attenuators.

The servo drive pump described above is far more efficient than an intensifier pump while still offering the desired ability to be able to store and hold pressure while not cutting, thus using only minimal power. The rotor shaft is designed to run at about 1500 rpm and the piston is about 180 mm in length running in a bore with a head diameter of between 14 mm and 22 mm. This makes the whole assembly small, light and considerably quieter than an intensifier pump. The servo drive system is also very responsive and pressures can be adjusted within milliseconds with infinite control.

The pressure feedback loop also enables ready diagnostics of leaks within the system. Through combination of current, position/velocity and pressure, a leak from the low pressure check valve 73 also known as an inlet check valve can be determined. These are regular maintenance items on ultra high pressure pumps, and regularly get small fragments of the wearing components between the sealing surfaces allowing the water to go back down the inlet water supply instead of building up pressure. This would mean that a system without the pressure transducer between the high pressure check valve 75 and the cutting head couldn't determine whether there was a leaking low pressure check valve or a blown high pressure hose or leaking high pressure fitting, because in both cases the current controller feedback (or any other measurement prior to the high pressure check valve) would read the same, whereas the reality is that a completely different response is required for each scenario. A leaking low pressure check valve would need increased velocity to compensate for the leak, whereas a blown high pressure hose or leaking high pressure fitting requires an emergency stop to avoid possible injury. There are numerous scenarios where using the current feedback (or any other measurement prior to the high pressure check valve) to determine pressure, would not be able to correctly diagnose a problem, these include: collapsing guide bush, collapsing seal backing ring, cracked or failed cylinder, seizing bearings or screw, and failed check valves.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. An ultra high pressure pump comprising a servo motor coupled to a piston having a head arranged within a cylinder to define a pumping chamber, whereby the servo motor rotation causes reciprocal displacement of the piston to pressurise fluid in the pumping chamber to pressures greater than 50,000 psi, the servo motor having a feedback loop coupled to a computer, the feedback loop including a pressure feedback signal to control the pump pressure in real time.

2. The ultra high pressure pump according to claim 1, wherein the servo motor includes an encoder to monitor the position and/or velocity of the motor.

3. The ultra high pressure pump according to claim 1, including means to monitor the current flowing through the motor.

4. The ultra high pressure pump according to claim 1 wherein the outlet of the pumping chamber is coupled to a pressure transducer that provides the pressure feedback signal.

5. The ultra high pressure pump according to claim 1 wherein the output of the servo motor is a reciprocating drive means having opposed ends, each end being coupled to a piston cylinder defining a pumping chamber.

6. An ultra high pressure pump comprising a servo motor adapted to axially rotate a hollow rotor shaft in alternating directions, the servo motor having a stator positioned co-axially around the hollow rotor shaft with the interior of the rotor shaft being co-axially coupled to drive means to convert axial rotation into reciprocal displacement, the drive means having opposed ends, each end coupled to a piston having a head arranged within a cylinder to define a pumping chamber between the head of the piston and the cylinder, whereby alternating rotation of the rotor shaft causes reciprocal linear displacement of the pistons to pressurise fluid in the pumping chambers to pressures greater than 50,000 psi, the servo motor including an encoder to monitor position or velocity of the drive means, means to monitor the current flowing through the stator and a pressure sensor coupled to the output of the pumping chambers, whereby signals from the encoder, pressure sensor and stator are fed back to a computerised control unit to ensure that the pump operates at a selected pressure.

7. A water jet cutting machine comprising a cutting head driven by a computer numerical controlled (CNC) controller, the cutting head being coupled to an ultra high pressure pump according to any one of the preceding claims, whereby control of the pressure of the pump is independent of the control of the cutting head.

8. A method of operating a water jet cutting machine comprising supplying cutting medium at a pressure of greater than 50,000 psi from a pump driven by a servo motor with a feedback loop, using a computer to control, in real time, the supply pressure by monitoring the position or velocity of the servo motor, the current supplied to the servo motor and the output pressure of the pump.
